(19) United States
(12) Patent Application Publication
(10) Pub. No.: US 2025/0218167 A1
(43) Pub. Date: Jul. 3, 2025

(54) MULTI-TASK LEARNING METHOD AND AN APPARATUS THEREOF

(71) Applicants: HYUNDAI MOTOR COMPANY, Seoul (KR); KIA CORPORATION, Seoul (KR)

(72) Inventors: Geon Kang, Pyeongtaek-si (KR); Yu Jin Yun, Seoul (KR); Jung Gee Kim, Seoul (KR)

(73) Assignees: HYUNDAI MOTOR COMPANY, Seoul (KR); KIA CORPORATION, Seoul (KR)

(21) Appl. No.: 18/789,052

(22) Filed: Jul. 30, 2024

(30) Foreign Application Priority Data
Jan. 3, 2024 (KR) 10-2024-0001035

(51) Int. Cl. G06V 10/82; G06V 10/80

(52) U.S. Cl. CPC G06V 10/82; G06V 10/803

(57) ABSTRACT

A multi-task learning method includes performing a first task in which there is no ground truth for an input image in a multi-task to predict a result of the first task. The multi-task learning method also includes performing at least one task in which there is ground truth with respect to a generation image generated by concatenating the predicted result of the first task and the input image to predict a result of the at least one task. The multi-task learning method additionally includes training the multi-task such that a loss function between the predicted result of the at least one task and ground truth of the at least one task is minimized.

### CROSS-REFERENCE TO RELATED APPLICATION

This application claims the benefit of and priority to Korean Patent Application No. 10-2024-0001035, filed on Jan. 3, 2024, the entire contents of which are hereby incorporated herein by reference.

### TECHNICAL FIELD

The present disclosure relates to technologies for training a multi-task, and more particularly, relates to a multi-task learning method and apparatus for training a multi-task based on semi-supervised learning.

### BACKGROUND

Multi-task learning is a technique for simultaneously training a plurality of tasks by means of one model to improve the performance of the model. It is known that the multi-task learning shows higher performance than single-task learning when there are a large number of tasks and a small number of data samples that belong to each task. Particularly, if there are a small number of data samples that belong to a target task, the multi-task learning may be used to improve the performance of the model.

Existing multi-task learning can only be performed for a paired dataset in which there is ground truth (GT) for each task with respect to one input.

Because existing data is a dataset in which only GT of each task is constructed, and that the dataset cannot be used for multi-task learning, training data for multi-task should be newly constructed. Thus, a lot of money and time are consumed.

Because an existing method using a pseudo label should train a single task model, it takes a long time to prepare for learning. Because existing methodologies for training an additional module according should train a module for each task, it takes a long time to learn and the convergence rate is slow because there are a large number of training parameters due to a complex training framework.

The statements in this section merely provide background information related to the present disclosure and may not constitute prior art.

### SUMMARY

The present disclosure has been made to solve the above-mentioned problems occurring in the prior art while advantages achieved by the prior art are maintained intact.

Aspects of the present disclosure provide a multi-task learning method for training a multi-task based on semi-supervised learning and an apparatus thereof.

Aspects of the present disclosure provide a multi-task learning method for training a multi-task using a dataset constructed for each task to reduce a multi-task learning time and improve a convergence rate and an apparatus thereof.

Aspects of the present disclosure provide a multi-task learning method for securing stable performance of a multi-task using a dataset constructed for each task and an apparatus thereof.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a multi-tasking learning apparatus may include a memory storing computer-executable instructions and at least one processor that accesses the memory and executes the computer-executable instructions. The at least one processor may be configured to perform a first task in which there is no ground truth for an input image in a multi-task to predict a result of the first task. The at least one processor may also be configured to perform at least one task in which there is ground truth with respect to a generation image generated by concatenating the predicted result of the first task and the input image to predict a result of the at least one task. The at least one processor may additionally be configured to train the multi-task such that a loss function between the predicted result of the at least one task and ground truth of the at least one task is minimized.

According to an embodiment, the at least one processor may be configured to update a weight of each of networks for performing the at least one task and may apply a trainable parameter for the at least one task to the generation image to predict the result of the at least one task.

According to an embodiment, the trainable parameter may include a first parameter and a second parameter. The at least one processor may be configured to multiply an output of each of the networks for performing the at least one task by the first parameter and may add the second parameter to the multiplied value to predict the result of the at least one task.

According to an embodiment, the at least one processor may be configured to update the weight of each of the networks for performing the at least one task through an exponential moving average (EMA) update.

According to an embodiment, the at least one processor may be configured to train the multi-task using a cross entropy loss, if the at least one task is a task for performing segmentation. The at least one processor may also be configured to train the multi-task using a mean square error, if the at least one task is a task for detecting depth.

According to an embodiment, the at least one processor may be configured to train the multi-task such that a loss function between a predicted result of the at least one task for the input image and the ground truth of the at least one task and the loss function between the predicted result of the at least one task for the generation image and the ground truth of the at least one task are minimized.

According to another aspect of the present disclosure, a multi-tasking learning method may include performing a first task in which there is no ground truth for an input image in a multi-task to predict a result of the first task. The multi-tasking learning method may also include performing at least one task in which there is ground truth with respect to a generation image generated by concatenating the predicted result of the first task and the input image to predict a result of the at least one task. The multi-tasking learning method may additionally include training the multi-task such that a loss function between the predicted result of the at least one task and ground truth of the at least one task is minimized.

According to an embodiment, predicting the result of the at least one task may include updating a weight of each of networks for performing the at least one task and applying a trainable parameter for the at least one task to the generation image to predict the result of the at least one task.

According to an embodiment, the trainable parameter may include a first parameter and a second parameter. Predicting the result of the at least one task may include multiplying an output of each of the networks for performing the at least one task by the first parameter and adding the second parameter to the multiplied value to predict the result of the at least one task.

According to an embodiment, predicting the result of the at least one task may include updating the weight of each of the networks for performing the at least one task through an exponential moving average (EMA) update.

According to an embodiment, training the multi-task may include training the multi-task using a cross entropy loss, if the at least one task is a task for performing segmentation, and training the multi-task using a mean square error, if the at least one task is a task for detecting depth.

According to an embodiment, training the multi-task may include training the multi-task such that a loss function between a predicted result of the at least one task for the input image and the ground truth of the at least one task and the loss function between the predicted result of the at least one task for the generation image and the ground truth of the at least one task are minimized.

The features briefly summarized above with respect to the present disclosure are merely illustrative aspects of the present disclosure, and do not limit the scope of the present disclosure.

### BRIEF DESCRIPTION OF THE DRAWINGS

The above and other objects, features, and advantages of the present disclosure should be more apparent from the following detailed description taken in conjunction with the accompanying drawings, in which:

FIG. 1 illustrates an operational flowchart for a multi-task learning method, according to an embodiment of the present disclosure;

FIG. 2 illustrates a drawing for describing a training process using data for multi-tasking, according to an embodiment of the present disclosure;

FIG. 3 illustrates a drawing for describing a training process using data in which there is only a segmentation label, according to an embodiment of the present disclosure;

FIG. 4 illustrates a drawing for describing a training process using data in which there is only a depth label, according to an embodiment of the present disclosure;

FIGS. 5A and 5B are drawings for describing a model transform layer, according to an embodiment of the present disclosure;

FIG. 6 illustrates a configuration of a multi-task learning apparatus, according to an embodiment of the present disclosure; and

FIG. 7 illustrates a block diagram of a computing system for executing a multi-task learning method according to an embodiment of the present disclosure.

### DETAILED DESCRIPTION

Hereinafter, embodiments of the present disclosure are described more fully with reference to the accompanying drawings to such an extent as to enable one of ordinary skill in the art to implement embodiments of the present disclosure. However, the present disclosure may be embodied in many different forms and should not be construed as being limited to the embodiment set forth herein.

In the present disclosure, when it was determined that a detailed description of a well-known configuration or function may obscure the gist of the present disclosure, the detailed description thereof has been omitted. Parts not related to the description of the present disclosure are omitted in the drawings, and same or similar parts are denoted by same or similar reference numerals throughout the specification.

In the present disclosure, when one component is referred to as being “connected with” or “coupled to” another component, it includes not only a case where the one component is directly connected to the other component, but also a case where the one component is indirectly connected with the other with there are one or more other components or devices in between. In addition, when one component is referred to as “comprising”, “including” or “having” another component, it is meant that the component may further include other components without excluding other components as long as there is no contrary description.

In the present disclosure, the terms such as “first” and “second” are used only for the purpose of distinguishing one component from another, but do not limit an order, the importance, or the like of components unless specifically stated. Thus, a first component in an embodiment may be referred to as a second component in another embodiment in the scope of the present disclosure. Likewise, a second component in an embodiment may be referred to as a first component in another embodiment.

In the present disclosure, components that are distinguished from each other are only for clearly explaining each feature, and do not necessarily mean that the components are separated. For example, a plurality of components may be integrated to form a single hardware or software unit, or a single component may be distributed to form a plurality of hardware or software units. Thus, even if not specifically mentioned, the integrated or separate embodiments are also included in the scope of the present disclosure.

In the present disclosure, components described in various embodiments may not necessarily refer to essential components. Some of the described components may be optional components. Thus, an embodiment composed of a subset of components described herein is also included in the scope of the present disclosure. Also, embodiments that additionally includes one or more other components in addition to components described in various embodiments are also included in the scope of the present disclosure.

In the present disclosure, expressions of positional relationships used in the specification, for example, top, bottom, left, and right, are described for convenience of description. When viewing the drawings illustrated in the specification in reverse, the positional relationship described in the specification may be interpreted in the opposite way.

In the present disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

When a component, device, element, or the like of the present disclosure is described as having a purpose or performing an operation, function, or the like, the component, device, or element should be considered herein as being “configured to” meet that purpose or perform that operation or function.

Embodiments of the present disclosure may train a multi-task based on semi-supervised learning using training data for each task and using an encoding and decoding capability learned by a multi-task model as it is to recover ground truth (GT) prediction using an exponential moving average (EMA) update to make a convergence rate faster and improve training performance as compared to learning a fully trainable parameter.

Embodiments of the present disclosure may concatenate the predicted result of performing a task in which there is no GT for an input image and the input image to generate another image (hereinafter referred to as a “first image”) and may perform at least one task in which there is the GT for the input image with respect to the first image to train a multi-task based on a loss function between the predicted result for the at least one task and GT for the at least one task.

Embodiments of the present disclosure may reduce the number of trainable parameters using a model transform layer and may apply the trainable parameter for at least one task to train a multi-task, thus improving a convergence rate of multi-task learning.

The task in the technology of the present disclosure may refer to a task to be solved through machine learning or a task to be performed through machine learning. For example, when performing face recognition, expression recognition, gender classification, pose classification, or the like from face image, each of the face recognition, the expression recognition, the gender classification, and the pose classification may correspond to a separate task. As another example, when performing object recognition, distance recognition, space recognition, or the like for recognizing an object, such as a vehicle, a pedestrian, or a sign, from image data obtained in real time by a camera of an autonomous vehicle, each of the object recognition, the distance recognition, and the space recognition may correspond to a separate task.

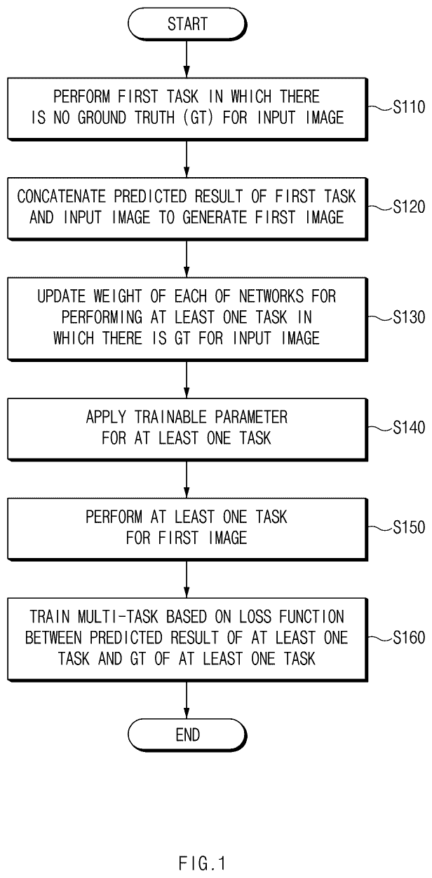

A description is provided below of a multi-task learning method and an apparatus thereof according to embodiments of the present disclosure with reference to FIGS. 1-6.

FIG. 1 illustrates an operational flowchart for a multi-task learning method, according to an embodiment of the present disclosure.

Referring to FIG. 1, when an input image included in training data is received, in an operation S110, a first task in which there is no ground truth (GT) for an input image in a multi-task may be performed.

For example, if training the multi-task for performing a segmentation task (or a space recognition task) and a depth task (or a distance recognition task), the depth task for an input image may be performed to output the result of predicting a depth of the input image, if the input image in which there is no depth GT is received. Further, the segmentation task for an input image may be performed to output the result of predicting segmentation of the input image, if the input image in which there is no segmentation GT is received.

In an embodiment, the operation S110 of performing the first task for the input image may be performed by a multi-task network to be trained. Of course, the multi-task network may include one backbone network and head networks respectively corresponding to tasks.

The backbone network may be a shared network and may be a network for extracting a common feature for an input image, which may provide the head network corresponding to each task with a common feature map for the input image.

Each of tasks may be performed by the head network corresponding to the task. Each of the head networks may refer to a network for performing a predetermined task and may perform a task, for example, segmentation recognition, depth recognition, or the like by using the output of the backbone network as the input.

In an operation S120, the predicted result of the first task and the input image may be concatenated to generate a first image corresponding to the input image.

For example, if the predicted result of the first task is a depth prediction result, the depth prediction result and the input image may be concatenated to generate a new image. If the predicted result of the first task is a segmentation prediction result, the segmentation prediction result and the input image may be concatenated to generate a new image.

In an operation S130, a weight of a multi-task network to be trained (hereinafter referred to as a “first multi-task network”) may be used to update a weight of the same multi-task network (hereinafter referred to as a “second multi-task network”) as the first multi-task network.

The operation S130 may be performed to update a weight of each of networks for performing at least one task in which there is GT for the input image in the second multi-task network.

According to an embodiment, the operation S130 may be performed to update the weight of the second multi-task network through an exponential moving average (EMA) update.

Exponential moving average (EMA) considers all historical periods for its calculation, but assigns larger weight and importance to the most recent data and uses a weight of an existing model without learning a weight of an EMA model, thus having a faster learning speed than using two networks. The EMA model may average parameters of the existing model to smoothly perform ensemble of the parameter over time. Because EMA is known to those having ordinary skill in the art, a detailed description thereof has been omitted.

In an operation S140, a trainable parameter may be applied to the at least one task, the EMA update of which is performed. In an operation S150, at least one task for the first image may be performed using the at least one task to which the trainable parameter is applied.

According to an embodiment, the trainable parameter may include a first parameter and a second parameter. The operation S150 may be performed to multiply an output of each of the networks for performing the at least one task by the first parameter and add the second parameter to the multiplied value to output the predicted result of the at least one task.

In an operation S160, a multi-task may be trained based on a loss function between the predicted result of the at least one task and GT of the at least one task for the input image.

According to an embodiment, the operation S160 may be performed to train the first multi-task network based on a loss function between the predicted result of the task, which is obtained by performing the task in which there is the GT for the input image in the first multi-task network, and the GT of the task for the input image and a loss function between the predicted result of the at least one task for the first image obtained by performing the task in the first multi-task network and GT of the at least one task for the input image.

The operation S160 may be performed to train the first multi-task network using a cross entropy loss, if the at least one task is a task for performing segmentation, and to train the first multi-task network using a mean square error, if the at least one task is a task for detecting depth.

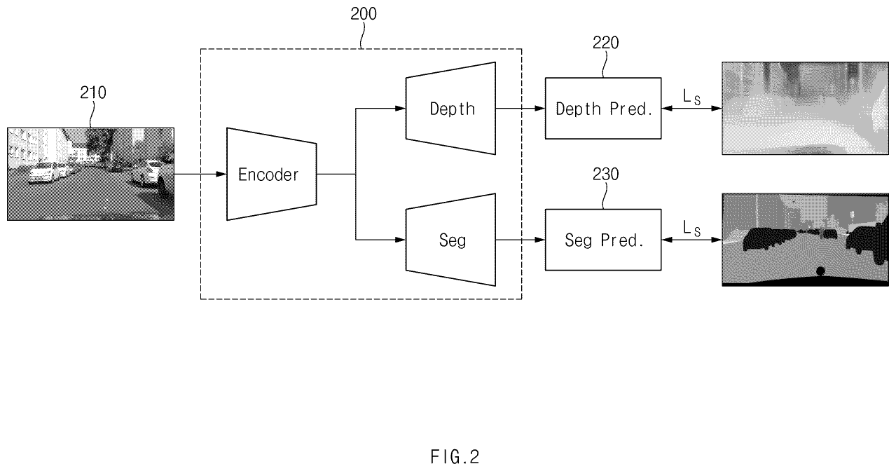

A description is given in detail of the method according to an embodiment of the present disclosure with reference to FIGS. 2-5B.

FIG. 2 illustrates a drawing for describing a training process using data for multi-tasking, according to an embodiment. FIG. 2 illustrates a drawing for describing a process of training a multi-task for performing a depth task and a segmentation task, according to an embodiment.

As shown in FIG. 2, if training a first multi-task network 200 using a dataset in which there is GT of each of tasks with respect to data for multi-task, i.e., input image 210, the first multi-task network 200 may be trained using a loss function between a predicted result of each of the tasks and GT of the input image for the task.

For example, when training a multi-task using data constructed for multi-task learning, an encoder network (or a backbone network) and a depth task network may be trained based on a loss function Ls between a depth prediction result 220 for an image 210 included in training data and depth GT of the image 210 and the encoder network (or the backbone network). Further, a segmentation task network may be trained based on a loss function Ls between a segmentation prediction result 230 for the image 210 and segmentation GT of the image 210 to train the first multi-task network 200. Such a method, according to an embodiment, proceeds in the same manner as before.

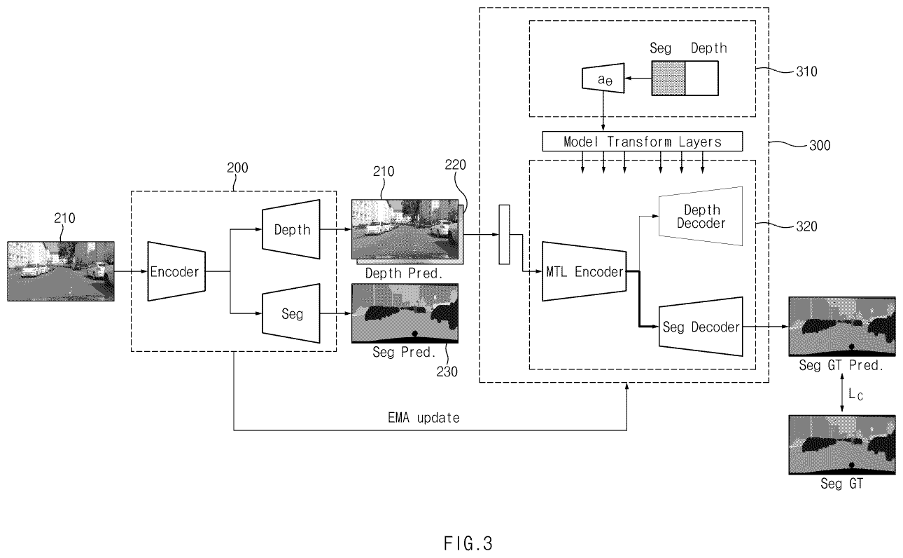

FIG. 3 illustrates a drawing for describing a training process using data in which there is only a segmentation label, according to an embodiment. FIG. 3 illustrates a drawing for describing a process of training a multi-task using training data in which there is only image GT for a segmentation task, according to an embodiment. In FIG. 3, a segmentation model in which there is GT may proceed with training like single model training.

As shown in FIG. 3, a method according to an embodiment of the present disclosure may be implemented to i) perform a depth task using a first multi-task network 200 with respect to an input image 210 including only segmentation GT to output a depth prediction result 220 for the input image 210 and ii) concatenate the depth prediction result 220 and the input image 210 to generate a first image for being input to a network 300 including a model transform layer or a model transform device 310 and a second multi-task network 320.

The second multi-task network 320 may update a weight of the first multi-task network 200 through an EMA update. The second multi-task network 320 may also apply a trainable parameter including a first parameter and a second parameter preset for a segmentation task to an MTL encoder and a segmentation decoder to perform the segmentation task for the first image and may perform the segmentation task for the first image to output a segmentation prediction result (Seg GT Pred.). The second multi-task network 320 may train the first multi-task network 200 based on a loss function Lc between the segmentation prediction result for the first image and segmentation GT for the input image 210. Herein, the loss function Lc between the segmentation prediction result for the first image and the segmentation GT for the input image 210 may refer to a cross entropy loss. Of course, the loss function Lc between the segmentation prediction result for the first image and the segmentation GT for the input image 210 is not necessarily the cross entropy loss.

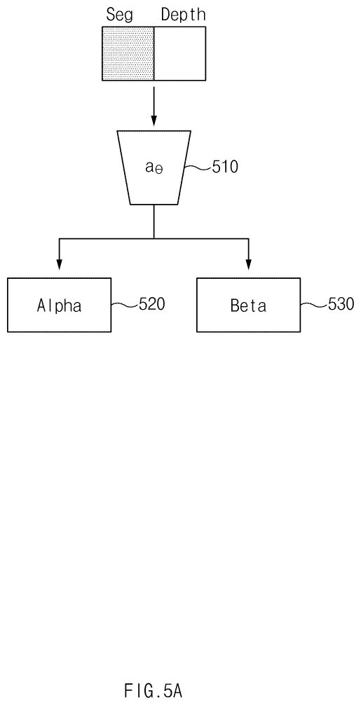

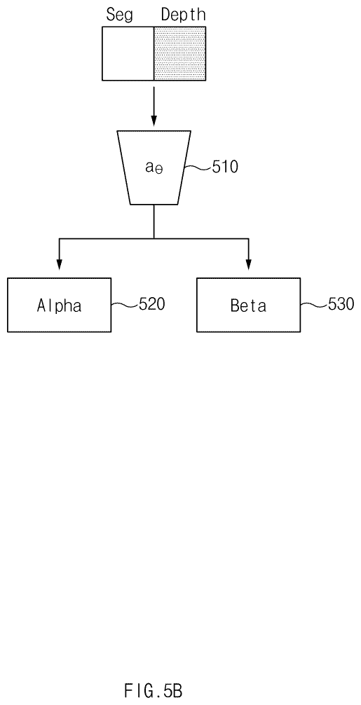

According to an embodiment, as shown in FIG. 5A, when performing training using input image data including only segmentation GT, the model transform layer or the model transform device 310 may receive matrix [1, 0] that signifies having the segmentation GT and may output a first parameter Alpha 520 and a second parameter Beta 530 preset for the segmentation task to the second multi-task network 320 through a fully connected layer a_{θ} 510.

Herein, if a convolution layer output channel of each of models of the second multi-task network 320 is C, then the first parameter 520 and the second parameter 530 may be a matrix of a 1×C size.

The model transform layer including a trainable parameter including the first parameter and the second parameter may perform training together. The model transform layer may multiply each network output by the first network and may add the second parameter to the multiplied value, thus outputting a segmentation prediction result.

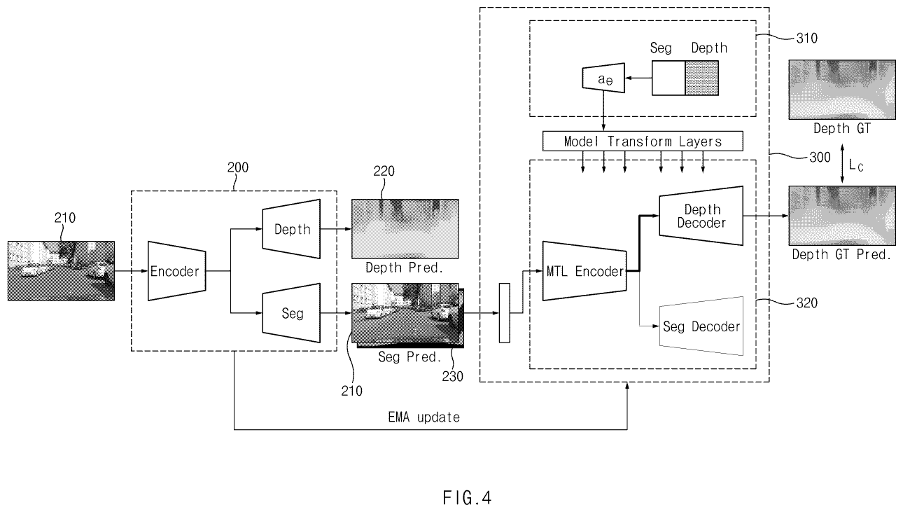

FIG. 4 illustrates a drawing for describing a training process using data in which there is only a depth label, according to an embodiment. FIG. 4 illustrates a drawing for describing a process of training a multi-task using training data in which there is only image GT for a depth task, according to an embodiment. FIGS. 5A and 5B are drawings for describing a model transform layer, according to an embodiment. In FIG. 4, a depth model in which there is GT may proceed with training like single model training.

As shown in FIG. 4, a method according to an embodiment of the present disclosure may i) perform a segmentation task using a first multi-task network 200 with respect to an input image 210 including only depth GT to output a segmentation prediction result 230 for the input image 210 and ii) concatenate the segmentation prediction result 230 and the input image 210 to generate a first image for being input to a network 300 including a model transform layer or a model transform device 310 and a second multi-task network 320.

The second multi-task network 320 may update a weight of the first multi-task network 200 through an EMA update. The second multi-task network 320 may also apply a trainable parameter including a first parameter and a second parameter preset for a depth task to an MTL encoder and a depth decoder to perform the depth task for the first image and may perform the depth task for the first image to output a depth prediction result (Depth GT Pred.). The second multi-task network 320 may train the first multi-task network 200 based on a loss function Lc between the depth prediction result for the first image and depth GT for the input image 210. Herein, the loss function Lc between the depth prediction result for the first image and the depth GT for the input image 210 may refer to a mean square error. Of course, the loss function Lc between the depth prediction result for the first image and the depth GT for the input image 210 is not necessarily the mean square error.

According to an embodiment, as shown in FIG. 5B, when performing training using input image data including only depth GT, the model transform layer or the model transform device 310 may receive matrix [0, 1] that signifies having the depth GT and may output a first parameter Alpha 520 and a second parameter Beta 530 preset for the depth task to the second multi-task network 320 through a fully connected layer a_{θ} 510.

The model transform layer including a trainable parameter including the first parameter and the second parameter may perform training together and may multiply each network output by the first network and may add the second parameter to the multiplied value, thus outputting a depth prediction result.

According to an embodiment, as shown in FIGS. 5A and 5B, the method according to an embodiment of the present disclosure may use the model transform layer to reduce the number of training parameters, thus improving a convergence rate of the model. For example, if 10 3×3 convolutions are a criterion when training a model, as the number of channels compressed increases, the trainable parameters greatly increase to C₁×C₂×3×3+ . . . ×C₁₀×3×3. On the other hand, in the method according to an embodiment of the present disclosure, the number of trainable parameters may decrease to 2×2×C₁+ . . . +2×2×C₁₁ due to a first parameter, a second parameter, and the number of tasks. Furthermore, the method according to an embodiment of the present disclosure may have a good influence on another task performance in concatenating and transforming the input image and the task prediction result. For example, the segmentation task may know distance information (depth), and the depth task may know pixel class information.

As such, the multi-task learning method according to an embodiment of the present disclosure may train a multi-task based on semi-supervised learning using a dataset previously constructed for each task, thus reducing a multi-task learning time, improving a convergence rate, and securing the stable performance of the multi-task.

Furthermore, unlike an existing method using a pseudo label, the multi-task learning method according to an embodiment of the present disclosure may perform online learning to shorten a time to train a single task model, and may use an encoding and decoding capability learned by a multi-task model using an EMA update as it is to recover GT prediction, thus making a convergence rate faster and more improving training performance than learning a fully trainable parameter.

Furthermore, the multi-task learning method according to an embodiment of the present disclosure may have no need to learn another segmentation/depth prediction and a depth/segmentation prediction module for each database (DB) to shorten a training time and may use all of a DB constructed for multi-task learning, a segmentation DB, a depth DB, and the like for the multi-task learning to reduce cost and time required to construct data.

The multi-task learning method according to an embodiment of the present disclosure may train the first multi-task shown in FIGS. 2-4 to perform a multi-task, such as depth recognition (or distance recognition) and segmentation recognition (or space recognition) from an image captured by a camera, in real time using the trained first multi-task, if the first multi-task is trained.

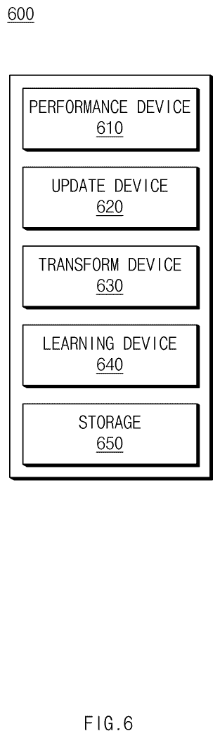

FIG. 6 illustrates a configuration of a multi-task learning apparatus according to an embodiment of the present disclosure. FIG. 6 illustrates a block diagram for a configuration of an apparatus for performing methods of FIGS. 1-5 and illustrates a conceptual configuration of an apparatus for training multi-task using a first multi-task network (or model) of FIGS. 3 and 4 and a second multi-task network, according to an embodiment.

Referring to FIG. 6, a multi-task learning apparatus 600 according to an embodiment of the present disclosure may include a performance device 610, an update device 620, a transform device 630, a learning device 640, and storage 650.

The storage 650 may be a configuration means, such as a memory, for storing all pieces of data for performing the multi-task learning apparatus 600 of the present disclosure. The storage 650 may store data such as a multi-task learning model, a training DB for multi-task, a training DB for each task, a multi-task learning algorithm for a technology of the present disclosure. The storage 650 may store all pieces of data associated with the technology of the present disclosure as well as the above-mentioned pieces of data.

If an input image included in a training data, for example, a multi-task learning model, a training DB for multi-task, a training DB for each task, or the like, is received, the performance device 610 may perform a first task in which there is no GT for the input image among tasks of a first multi-task network and may predict a result of the first task.

Furthermore, the performance device 610 may perform at least one task in which there is GT for the input image among tasks of a second multi-task network which receives a first image generated by concatenating the prediction result of the first task and the input image, thus predicting a result of the at least one task.

According to an embodiment, the performance device 610 may perform at least one task for the first image using at least one task model, a weight of which is updated by the update device 620, thus predicting the result of the at least one task.

According to an embodiment, the performance device 610 may perform at least one task for the first image using the second multi-task network to which a first parameter and a second parameter are applied by the transform device 630, thus predicting the result of the at least one task.

The update device 620 may update a weight of the second multi-task network using a weight of the first multi-task network.

According to an embodiment, the update device 620 may update the weight of the second multi-task network, for example, a network for performing at least one task in the second multi-task network, through an EMA update using the weight of the first multi-task network.

The transform device 630 may apply a trainable parameter including a first parameter and a second parameter preset for at least one task to the second multi-task network, the weight of which is updated.

According to an embodiment, the transform device 630 may differently set the first parameter and the second parameter depending on the task performed by the second multi-task network.

According to an embodiment, the transform device 630 may multiply an output of each of networks for performing at least one task by the first parameter and adding the second parameter to the multiplied value, thus applying the first parameter and the second parameter set for the task to the second multi-task network.

The learning device 640 may train the first multi-task network based on a loss function between the predicted result of the at least one task that is output by the performance device 610, and GT of the input image for the task.

According to an embodiment, the learning device 640 may train the first multi-task network based on a loss function Ls between the predicted result of the task of the first multi-task network in which there is GT for the input image and GT of the input image for the task and a loss function Lc between the predicted result of the at least one task for the first image and GT of the at least one task for the input image.

According to an embodiment, the learning device 640 may train the first multi-task network using a cross entropy loss, if the at least one task is a task for performing segmentation. The learning device 640 may train the first multi-task network using a mean square error, if the at least one task is a task for detecting depth.

Although a more detailed description of the multi-task learning apparatus 600 according to an embodiment of the present disclosure is omitted, the multi-task learning apparatus 600 according to an embodiment of the present disclosure may include all contents described in the method of FIGS. 1-5. This is apparent to those having ordinary skill in the art to which the present disclosure pertains.

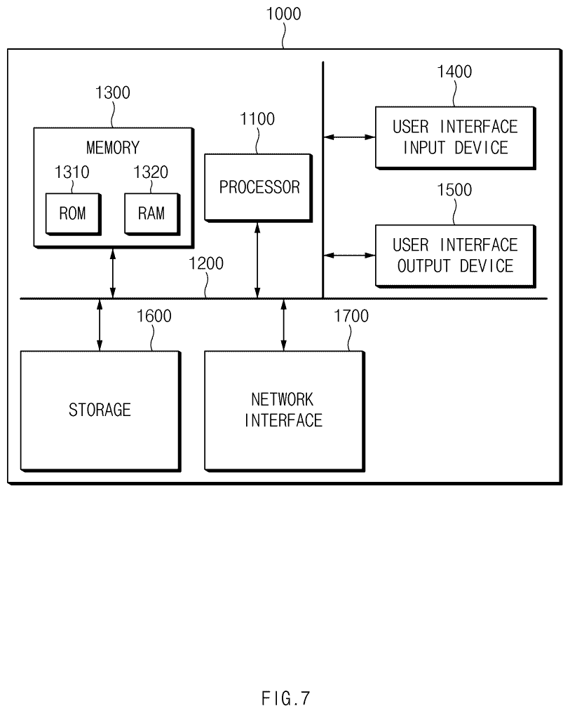

FIG. 7 illustrates a block diagram of a computing system for executing a multi-task learning method, according to an embodiment of the present disclosure.

Referring to FIG. 7, the multi-task learning method according to an embodiment of the present disclosure may be implemented by means of a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the present specification may be directly implemented with a hardware module, a software module, or a combination of the hardware module and the software module executed by the processor 1100. The software module may reside on a storage medium (that is, the memory and/or the storage) such as a RAM, a flash memory, a ROM, an EPROM, an EEPROM, a register, a hard disc, a removable disk, and a CD-ROM. The storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another example, the processor 1100 and the storage medium may reside in the user terminal as separate components.

The above-described embodiments may be implemented with hardware components, software components, and/or a combination of hardware components and software components. For example, the devices, methods, and elements described in the present disclosure may be implemented by using one or more general-use computers or special-purpose computers, such as a processor, a controller, an arithmetic logic unit (ALU), a digital signal processor, a microcomputer, a field programmable array (FPA), a programmable logic unit (PLU), a microprocessor, or any device which may execute instructions and respond. A processing unit may perform an operating system (OS) or one or software applications running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be stored in one or more computer-readable storage media.

The methods according to embodiments may be implemented in the form of program instructions that may be executed through various computer means and may be recorded in computer-readable media. The computer-readable media may also include, alone or in combination with the program instructions, data files, data structures, and the like. The program instructions recorded in the media may be designed and configured specially for the embodiments of the inventive concept or be known and available to those having ordinary skill in computer software. Examples of computer-readable media include: magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described embodiments of the inventive concept, or vice versa.

Even though the embodiments are described with reference to the accompanying drawings, it should be understood by one having ordinary skill in the art that the present disclosure may be variously altered and modified based on the above description without departing from the scope and spirit of the present disclosure. For example, adequate effects may be achieved even if the foregoing processes and methods are carried out in different order than described above, and/or the aforementioned elements, such as systems, structures, devices, or circuits, are combined or coupled in different forms and modes than described above or be substituted or switched with other components or equivalents.

According to embodiments of the present disclosure, the multi-task learning apparatus may train a multi-task based on semi-supervised learning.

According to embodiments of the present disclosure, the multi-task learning apparatus may train the multi-task using a dataset constructed for each task, thus reducing a multi-task learning time, improving a convergence rate, and securing the stable performance of the multi-task.

Furthermore, the multi-task learning apparatus may perform online learning to shorten a time to train a single task model, and may use an encoding and decoding capability learned by a multi-task model using an exponential moving average (EMA) update as it is to recover GT prediction, thus making a convergence rate faster and more improving training performance than learning a fully trainable parameter.

The effects that are achieved through the present disclosure may not be limited to the effects described above, and other advantages not described above may be more clearly understood from the foregoing detailed description by those having ordinary skill in the art to which the present disclosure pertains.

Hereinabove, although the present disclosure has been described with reference to embodiments and the accompanying drawings, the present disclosure is not limited thereto, but may be variously modified and altered by those having ordinary skill in the art to which the present disclosure pertains without departing from the spirit and scope of the present disclosure claimed in the following claims. Therefore, embodiments disclosed in the present disclosure are not intended to limit the technical spirit of the present disclosure. The scope of the technical spirit of the present disclosure is not limited by the described embodiments. The scope of the present disclosure should be construed on the basis of the accompanying claims, and all the technical ideas within the scope equivalent to the claims should be included in the scope of the present disclosure.

What is claimed is:

1. A multi-task learning apparatus, comprising:
a memory storing computer-executable instructions; and
at least one processor configured to access the memory and execute the computer-executable instructions,
wherein the at least one processor is configured to:
perform a first task in which there is no ground truth for an input image in a multi-task to predict a result of the first task,
perform at least one task in which there is ground truth with respect to a generation image generated by concatenating the predicted result of the first task and the input image to predict a result of the at least one task, and
train the multi-task such that a loss function between the predicted result of the at least one task and ground truth of the at least one task is minimized.

2. The multi-task learning apparatus of claim 1, wherein the at least one processor is configured to update a weight of each of networks for performing the at least one task and apply a trainable parameter for the at least one task to the generation image to predict the result of the at least one task.

3. The multi-task learning apparatus of claim 2, wherein:
the trainable parameter includes a first parameter and a second parameter; and
the at least one processor is configured to multiply an output of each of the networks for performing the at least one task by the first parameter and add the second parameter to the multiplied value to predict the result of the at least one task.

4. The multi-task learning apparatus of claim 2, wherein the at least one processor is configured to update the weight of each of the networks for performing the at least one task through an exponential moving average (EMA) update.

5. The multi-task learning apparatus of claim 1, wherein the at least one processor is configured to:
train the multi-task using a cross entropy loss, when the at least one task is a task for performing segmentation; and
train the multi-task using a mean square error, when the at least one task is a task for detecting depth.

6. The multi-task learning apparatus of claim 1, wherein the at least one processor is configured to train the multi-task such that a loss function between a predicted result of the at least one task for the input image and the ground truth of the at least one task and the loss function between the predicted result of the at least one task for the generation image and the ground truth of the at least one task are minimized.

7. A multi-task learning method, comprising:
performing a first task in which there is no ground truth for an input image in a multi-task to predict a result of the first task;
performing at least one task in which there is ground truth with respect to a generation image generated by concatenating the predicted result of the first task and the input image to predict a result of the at least one task; and
training the multi-task such that a loss function between the predicted result of the at least one task and ground truth of the at least one task is minimized.

8. The multi-task learning method of claim 7, wherein predicting the result of the at least one task includes updating a weight of each of networks for performing the at least one task and applying a trainable parameter for the at least one task to the generation image to predict the result of the at least one task.

9. The multi-task learning method of claim 8, wherein:
the trainable parameter includes a first parameter and a second parameter; and
predicting the result of the at least one task includes multiplying an output of each of the networks for performing the at least one task by the first parameter and adding the second parameter to the multiplied value to predict the result of the at least one task.

10. The multi-task learning method of claim 8, wherein predicting the result of the at least one task includes updating the weight of each of the networks for performing the at least one task through an exponential moving average (EMA) update.

11. The multi-task learning method of claim 7, wherein training the multi-task includes:
training the multi-task using a cross entropy loss, when the at least one task is a task for performing segmentation; and
training the multi-task using a mean square error, when the at least one task is a task for detecting depth.

12. The multi-task learning method of claim 7, wherein training the multi-task includes training the multi-task such that a loss function between a predicted result of the at least one task for the input image and the ground truth of the at least one task and the loss function between the predicted result of the at least one task for the generation image and the ground truth of the at least one task are minimized.
